(19) United States
(12) Patent Application Publication
(10) Pub. No.: US 2025/0139518 A1
(43) Pub. Date: May 1, 2025

(54) LEARNING DEVICE AND LEARNING METHOD

(71) Applicant: NEC Corporation, Tokyo (JP)

(72) Inventor: Yasuharu OKAMOTO, Tokyo (JP)

(73) Assignee: NEC Corporation, Tokyo (JP)

(21) Appl. No.: 18/903,319

(22) Filed: Oct. 1, 2024

(30) Foreign Application Priority Data
Oct. 30, 2023 (JP) 2023-185221

(51) Int. Cl. G06N 20/00

(52) U.S. Cl. CPC G06N 20/00

(57) ABSTRACT

The learning unit, when obtaining parameters of second-order cross terms of feature values and a constant term in a predetermined prediction model, performs first learning to obtain the constant term and latent vectors based on training data and to obtain the parameters by obtaining inner product of the latent vectors. The feature value selection unit, when the number of the feature values in a subset of the feature values is denoted as L and the number of the subsets is denoted as m, performs first feature value selection to create m subsets of the feature values including L feature values by optimizing objective function including the parameters and to select a predetermined number of feature values. The learning unit obtains the constant term and the parameters by performing second learning similar to the first learning using the feature values included in each subset.

### INCORPORATION BY REFERENCE

This application is based upon and claims the benefit of priority from Japanese patent application No. 2023-185221, filed on Oct. 30, 2023, the disclosure of which is incorporated herein in its entirety by reference.

### TECHNICAL FIELD

The present disclosure relates to a learning device, a learning method, and a learning program.

### BACKGROUND ART

NPL 1 describes the FFM (field-aware factorization machine).

### CITATION LIST

### Non Patent Literature

NPL 1: Yuchin Juan et al., “Field-aware Factorization Machines for CTR Prediction”, [retrieved on Sep. 6, 2023], Internet <URL: https://www.csie.ntu.edu.tw/˜cjlin/papers/ffm.pdf>

### SUMMARY

The purpose of the present invention is to provide a learning device, a learning method, and a learning program that can make a prediction model smaller.

A learning device according to the present disclosure includes: a memory configured to store instructions; a processor configured to execute the instructions to: when obtaining parameters of second-order cross terms of feature values and a constant term in a predetermined prediction model, perform first learning to obtain the constant term and latent vectors based on training data and to obtain the parameters by obtaining inner product of the latent vectors; when the number of the feature values in a subset of the feature values is denoted as L and the number of the subsets is denoted as m, perform first feature value selection to create m subsets of the feature values including L feature values by optimizing objective function including the parameters and to select a predetermined number of feature values; obtain the constant term and the parameters by performing second learning similar to the first learning using the feature values included in each subset, perform second feature value selection similar to the first feature value selection after the second learning, and generate a prediction model including an indicator function based on the constant term obtained by the second learning and the feature values selected by the second feature value selection.

A learning method according to the present disclosure is implemented by a computer, and includes: when obtaining parameters of second-order cross terms of feature values and a constant term in a predetermined prediction model, performing first learning to obtain the constant term and latent vectors based on training data and to obtain the parameters by obtaining inner product of the latent vectors; when the number of the feature values in a subset of the feature values is denoted as L and the number of the subsets is denoted as m, performing first feature value selection to create m subsets of the feature values including L feature values by optimizing objective function including the parameters and to select a predetermined number of feature values; obtaining the constant term and the parameters by performing second learning similar to the first learning using the feature values included in each subset; performing second feature value selection similar to the first feature value selection after the second learning; and generating a prediction model including an indicator function based on the constant term obtained by the second learning and the feature values selected by the second feature value selection.

A non-transitory computer-readable recording medium according to the present disclosure is a non-transitory computer-readable recording medium in which a learning program is stored, wherein the learning program causes a computer to execute: a process of, when obtaining parameters of second-order cross terms of feature values and a constant term in a predetermined prediction model, performing first learning to obtain the constant term and latent vectors based on training data and to obtain the parameters by obtaining inner product of the latent vectors; a process of, when the number of the feature values in a subset of the feature values is denoted as L and the number of the subsets is denoted as m, performing first feature value selection to create m subsets of the feature values including L feature values by optimizing objective function including the parameters and to select a predetermined number of feature values; a process of obtaining the constant term and the parameters by performing second learning similar to the first learning using the feature values included in each subset; a process of performing second feature value selection similar to the first feature value selection after the second learning; and a process of generating a prediction model including an indicator function based on the constant term obtained by the second learning and the feature values selected by the second feature value selection.

### BRIEF DESCRIPTION OF THE DRAWINGS

FIG. 1 It depicts a schematic diagram showing the processing steps of the learning device of the present disclosure.

FIG. 2 It depicts a block diagram showing an example configuration of the learning device of the present disclosure.

FIG. 3 It depicts a schematic diagram showing the behavior of loss when L is varied in each case of m=1 to m=5.

FIG. 4 It depicts scatter plots of true values and predicted values.

FIG. 5 It depicts a scatter plot of true values and predicted values regarding the test data.

FIG. 6 It depicts an explanatory diagram showing the transition of the coefficient of determination obtained in example 3.

FIG. 7 It depicts an explanatory diagram showing the respective coefficients of determination when the number of epochs in the first learning is 20, 50, 75, 100, and 300.

FIG. 8 It depicts a schematic block diagram showing an example configuration of a computer related to the learning device.

FIG. 9 It depicts a block diagram showing an overview of the learning device of the present disclosure.

### EXAMPLE EMBODIMENT

The following is a description of the example embodiment of the learning device of the present disclosure. For convenience, the hat symbol may be shifted from variable in this specification.

The learning device of the present disclosure generates a prediction model after repeating learning and feature value selection twice for a second-order learning model. An FFM learning model is used as the learning model. The FFM is an extension of the FM (Factorization Machine).

In the FM, feature values are expanded by latent vectors in order to compute the cross terms of the feature values. However, in the FM, the latent vector of feature value A is identical for both feature values B and C, which may reduce the descriptive power of the learning model.

The FFM, on the other hand, considers feature value as field and assigns a latent vector to each field.

For example, assume that there are three feature values: “gender,” “purchase history of product A,” and “purchase history of product B.” In the FM, the latent vector of “gender” for “purchase history of product A” and the latent vector of “gender” for “purchase history of product B” are the same. However, in the FFM, the latent vector of “gender” for “purchase history of product A” and the latent vector of “gender” for “purchase history of product B” are different, which increases the descriptive power of the learning model.

The FM and the FFM are further explained.

For example, a linear regression model with y as the objective variable and three explanatory variables x₁, x₂, x₃ is expressed as following expression.

$$y = {w}_{1} {x}_{1} + {w}_{2} {x}_{2} + {w}_{3} {x}_{3}$$

A regression model are not limited to the above example; regression models involving products of explanatory variables such as x₁x₂ are also used. The product of the explanatory variables such as x₁x₂ is called the cross term. An example of such a regression model is shown below.

$$y = {w}_{1} {x}_{1} + {w}_{2} {x}_{2} + {w}_{3} {x}_{3} + {w}_{12} {x}_{1} {x}_{2} + {w}_{23} {x}_{2} {x}_{3} + {w}_{13} {x}_{1} {x}_{3}$$

In a regression model that includes cross terms, the descriptive power of the regression model increases as the number of parameters increases. However, a large number of cross terms may lead to the problem of increased computational load and lack of data corresponding to the cross terms. In the FM, to solve such problems, the parameter wₗ₁ₗ₂ of the cross terms is approximated by the inner product of the latent vectors v of the K terms. This approximation is expressed by the following expression.

$${w}_{{l}_{1} {l}_{2}} ∼ {\sum }_{m = 1}^{K} {v}_{{l}_{1}}^{m} {v}_{{l}_{2}}^{m} \qquad [ Math . 1 ]$$

When the number of explanatory variables is N, the number of cross terms is N(N−1)/2, and the number of parameters (wₗ₁ₗ₂) required for cross terms is also N(N−1)/2. In the FM, N(N−1)/2 cross terms can be represented by NK parameters (vₗ^{m}). However, the parameter vₗ₁^{m} is determined independently of the pairs of crossings (explanatory variable l₂), which may reduce the descriptive power of the regression model.

Therefore, in the FFM, a quantity that is called a field that summarizes several explanatory variables is defined and a latent vector (v_{l1f(l2)}^{m}) for each field is set. f(l₂) refers to the field to which the explanatory variable l₂ belongs. In this case, the approximation of the parameter wₗ₁ₗ₂ of the cross term is expressed by the following expression.

$${w}_{{l}_{1} {l}_{2}} ∼ {\sum }_{m = 1}^{K} {v}_{{l}_{1} f ( {l}_{2} )}^{m} {v}_{{l}_{2} f ( {l}_{1} )}^{m} \qquad [ Math . 2 ]$$

For the sake of concreteness, the case of using a data set that shows the relationship between 10 feature values of a diabetic patient, such as age, gender, BMI (Body Mass Index), and blood pressure value, and the progression of the disease after one year is taken. Then, all 442 data shall be randomly divided so that the ratio of training data to test data is 3:1. This type of data is also used in the examples described below. However, the items included in the data set, the number of data, and the ratio of training data to test data are not limited to the above example.

In optimization by the Ising model, it is easier to implement when quantitative variables are divided into categories and treated as categorical variables.

For example, an ordinal scale shall be introduced for 9 of the 10 feature values (quantitative variables), excluding gender, to convert each feature value (quantitative variable) into a categorical variable consisting of 4 groups. Specifically, each quantitative variable shall be arranged in ascending order and divided into four groups by quartiles. Note that as for gender, it is a categorical variable from the beginning. In the examples described below, quantitative variables are also converted into categorical variables in this way. However, one quantitative variable may be divided into groups other than the four groups. Since the quantitative variable is converted into a categorical variable, the number of fields remains the original 10. In addition, gender is split into two groups, and the other nine feature values are split into four groups. Thus, the number of feature values is effectively 38. The number of cross terms for these feature values is 703.

The predicted value yᵢ\hat{ } for the i-th data when second-order cross terms are taken into account is expressed in expression (1) below.

$$[ Math . 3 ]$$

$${\hat{y}}_{i} = {w}_{0} + {\sum }_{l = 1}^{D} {w}_{l} {q}_{il} + {\sum }_{{l}_{2} > {l}_{1}}^{D} {w}_{{l}_{1} {l}_{2}} {q}_{{il}_{1}} {q}_{{il}_{2}} \qquad ( 1 )$$

Expression (1) is the original prediction model subject to small scale. In expression (1), qᵢ₁ is the 0/1 binary variable for the l-th feature value of the i-th data and is given by the input data. Similarly, qᵢₗ₁ is the 0/1 binary variable for the l₁-th feature value of the i-th data and is given by the input data. qᵢ₁₂ is the 0/1 binary variable for the l₂-th feature value of the i-th data and is given by the input data.

The w₀ (constant term), w₁, and wₗ₁ₗ₂ in expression (1) are parameters determined by learning with the FFM based on training data. More specifically, in the FFM, w₀, w₁, and the latent vectors v of the K-term expansion are determined by learning, and the second-order parameters wₗ₁ₗ₂ are determined as the inner product of the latent vectors. The second-order parameters wₗ₁ₗ₂ are expressed by the following approximation in expression (2) as the inner product of the latent vectors v.

$$[ Math . 4 ]$$

$${w}_{{l}_{1} {l}_{2}} ∼ {\sum }_{k = 1}^{K} {v}_{{l}_{1} f ( {l}_{2} )}^{k} {v}_{{l}_{2} f ( {l}_{1} )}^{k} \qquad ( 2 )$$

The parameters w₀, w₁, and the latent vectors v_{lf}^{k} are optimized by applying the stochastic gradient descent method to the residual sum of squares in expression (1). In this example, the total number of epochs of learning to find the parameters w₀, w₁, and the latent vectors v_{lf}^{k} is assumed to be 300 unless otherwise noted. In the examples described below, the number of epochs is also assumed to be 300. However, the number of epochs is not limited to 300.

As above, w₀, w₁, and wₗ₁ₗ₂ are obtained, but w₁ is not used in the subsequent process.

Let the number of feature values (number of elements) in a subset of feature values be L and the number of subsets be m. After obtaining w₀, w₁, and wₗ₁ₗ₂, select feature values by creating m subsets S_{g}(g=1, . . . , m) containing L feature values from among N feature values (38 in this example).

Also, consider the cross terms that can be generated within each subset. This corresponds to selecting two feature values out of L feature values, so for each subset, the number of cross terms is _{L}C₂=L(L−1)/2. In order to treat the m subsets independently, the restriction is that the number of subsets to which each feature value to be selected belongs is at most one. The prediction model with cross terms generated from the sum of such subsets is given by the following expression (3).

$$[ Math . 5 ]$$

$${\hat{y}}_{k}^{{S}^{′}} = {w}^{( 0 )} + {\sum }_{{p}_{2} > {p}_{1}}^{D} {w}_{{p}_{1} {p}_{2}}^{( 2 )} {q}_{{kp}_{1}} {q}_{{kp}_{2}} {χ}_{{S}^{′}} ( [ {p}_{1} , {p}_{2} ] ) \qquad ( 3 )$$

Since the focus of the present disclosure is on the cross terms, the regression model in expression (3) includes a constant term and cross terms, but does not include a linear term.

w⁽⁰⁾, Wₚ₁ₚ₂⁽²⁾ in expression (3) are the same as w₀, wₗ₁ₗ₂ in expression (1), respectively. Also, qₖₚ₁ and qₖₚ₂ in expression (3) are the same as qᵢ₁₁ and qᵢ₁₂ in expression (1), respectively.

In expression (3), S′ is a set obtained by summing the cross terms that can be generated from each of the subsets described above for m subsets. Cross terms that span two subsets are not included in S′.

In addition, χ_{s′}([i,j]) in expression (3) is an indicator function, and χ_{s′}([i,j]) is 1 if the (i,j) element of the cross term is included in the set S′; otherwise, χ_{s′}([i,j]) is 0. In other words, χ_{s′}([i,j]) is expressed by the following expression (4).

$$[ Math . 6 ]$$

$${χ}_{{S}^{′}} ( [ i , j ] ) := \{ \begin{matrix}1 if ( i , j ) ∈ {S}^{′} , \\ 0 if ( i , j ) ∉ {S}^{′}\end{matrix} \qquad ( 4 )$$

Cross terms with large absolute values of the parameters are important. To select them, the objective function of optimization by the Ising model is defined as the following expression (5) so that the sum of absolute values of the parameters wₗ₁ₗ₂ is maximized.

$$[ Math . 7 ]$$

$$𝒥 = - {\sum }_{g} ( {\sum }_{i , j} \vert {w}_{i , j} \vert {x}_{ig} {x}_{jg} ) + A {\sum }_{i} ( {\sum }_{g} {x}_{ig} ) ( {\sum }_{{g}^{′}} {x}_{{ig}^{′}} - 1 ) + B {\sum }_{g} {( {\sum }_{i} {x}_{ig} - L )}^{2} \qquad ( 5 )$$

In expression (5), wᵢⱼ is the same as wₗ₁ₗ₂ in expression (1). Note that in expression (5), a minus sign is added to the first term on the right side to handle the minimization problem.

In expression (5), x_{ig} is a binary variable that is 1 if the i-th feature value belongs to the subset S_{g} and 0 otherwise. In addition, x_{ig} is the variable subject to optimization by the Ising model. The relationship between the indicator function χ_{s′}([i,j]) described above and the variable x_{ig} is expressed by the following expression (6).

$$[ Math . 8 ]$$

$${χ}_{{S}^{′}} ( [ i , j ] ) = {\sum }_{g} {x}_{ig} {x}_{jg} \qquad ( 6 )$$

The first term on the right side of expression (5) is the term for maximizing the sum of absolute values of the parameter wᵢⱼ. The second term on the right side of expression (5) is the term corresponding to the restriction that the number of subsets to which the i-th feature value belongs is at most one. The third term on the right side of expression (5) is a number that represents the restriction that the number of feature value in each subset be L. The values of L and m are specified externally.

By optimizing the objective function in expression (5), x_{ig} in expression (5) are obtained. This means that m subsets with L elements can be determined.

For example, assume that L=14 and m=2. Also, assume that the 38 feature values are assigned labels (identification information) from 0 to 37. By optimizing the objective function in expression (5), the following two subsets can be determined, for example.

S₁={1, 5, 6, 7, 8, 9, 10, 11, 13, 15, 23, 24, 27, 28}

S₂={4, 12, 19, 22, 25, 29, 30, 31, 32, 33, 34, 35, 36, 37}

This means that 28 feature values were selected. However, the above S₁, S₂ are examples of the selection results.

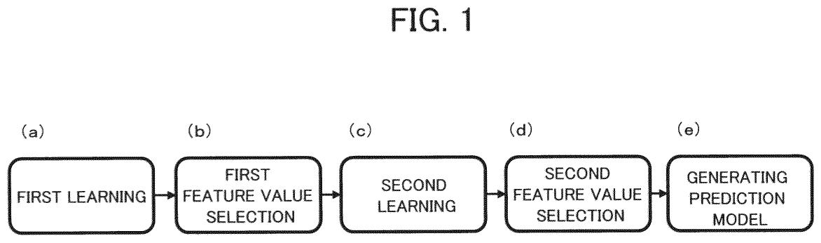

FIG. 1 shows a schematic diagram showing the processing steps of the learning device of the present disclosure. First, based on the training data, w₀, w₁, and wₗ₁ₗ₂ in expression (1) are obtained (process (a)). As mentioned earlier, w₀, w₁, and the latent vectors v are obtained based on the training data, and the second-order parameters wₗ₁ₗ₂ are obtained by obtaining the inner product of the latent vectors. This operation of process (a) corresponds to the first learning.

The wᵢⱼ in expression (5) is the same as the wₗ₁ₗ₂ obtained in process (a). Next to process (a), the first feature value selection is performed (process (b)). In process (b), m subsets of feature value are determined by optimizing the objective function in expression (5), where the number of elements is L. The feature values contained in each subset are the selected feature values.

Next to process (b), a second learning similar to the first learning is performed using the feature values selected in process (b) (process (c)). As a result, w₀, w₁, and wₗ₁ₗ₂ are again obtained.

Next to process (c), a second feature value selection similar to the first feature value selection is performed (process (d)). That is, m subsets of feature value are determined by optimizing the objective function in expression (5), where the number of elements is L. At this time, x_{ig} in expression (5) are obtained.

Different values may be specified as L in the first feature value selection and L in the second feature value selection. However, L in the first feature value selection is equal to or greater than L in the second feature value selection.

The next step in process (d) is to generate a prediction model expressed in the form of expression (3) (process (e)). The w⁽⁰⁾ in expression (3) is the w₀ obtained in the second learning (process (c)). The x_{ig} obtained in process (d) and expression (6) are used to obtain the indicator function χ_{s′}([i,j]), and the prediction model is generated by substituting the indicator function χ_{s′}([i,j]) into expression (3).

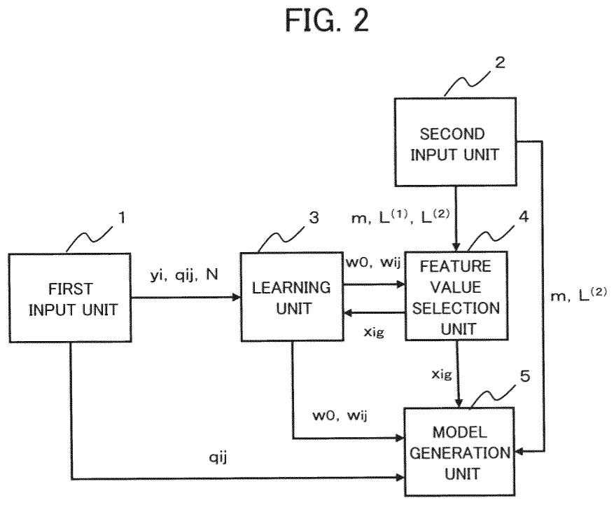

FIG. 2 is a block diagram showing an example configuration of the learning device of the present disclosure. The learning device of the present disclosure includes a first input unit 1, a second input unit 2, a learning unit 3, a feature value selection unit 4, and a model generation unit 5.

The first input unit 1 is an input interface for inputting the objective variable yᵢ (e.g., a variable indicating the progression of the disease after one year), the explanatory variables (feature values) qᵢⱼ, and the number N of the feature values. The feature values are assumed to be categorical variable before being input into the first input unit 1. Alternatively, feature values that have not been converted into categorical variable may be input to the first input unit 1, and the first input unit 1 may have the ability to convert the feature values into categorical variable. N is the number of feature values after they have been converted into categorical variable.

The second input unit 2 is an input interface for inputting the number of feature value subsets m, the number of feature values in each subset in the first feature value selection, L⁽¹⁾, and the number of feature values in each subset in the second feature value selection, L⁽²⁾. L⁽¹⁾ is equal to or greater than L⁽²⁾. The case where L (1)=L⁽²⁾ and the value is L is taken, as an example.

When the learning unit 3 obtains the parameters of the second-order cross terms of the feature values and the constant term in a predetermined prediction model (expression (1)), the learning unit 3 performs the first learning to obtain the constant term and the latent vectors based on the training data and to obtain the parameters by obtaining the inner product of the latent vectors.

More specifically, the learning unit 3 minimizes the loss function using the stochastic gradient descent method to the residual sum of squares in expression (1). As a result, w₀ and w₁ in expression (1) and the latent vectors v are obtained. Then, the parameters wₗ₁ₗ₂ of the cross terms are obtained by finding the inner product of the latent vectors v according to equation (2).

The feature value selection unit 4 performs the first feature value selection to create m subsets of feature values including L feature values by optimizing the objective function (expression (5)) including the parameters and to select a predetermined number of feature values. At this time, the restriction is set that the number of subsets to which each feature value to be selected belongs is at most one. This restriction is also applied to the second feature value selection.

Specifically, the feature value selection unit 4 obtains x_{ig} in expression (5) by optimizing the objective function in expression (5). As mentioned above, this means determining m subsets with L number of elements.

After the first feature value selection, the learning unit 3 performs the second learning similar to the first learning using the feature values included in each subset.

After the second learning, the feature value selection unit 4 performs the second feature value selection similar to the first feature value selection.

The model generation unit 5 generates the prediction model (expression (3)) including the indicator function based on the constant term obtained by the second learning and the feature values selected by the second feature value selection.

The w⁽⁰⁾ in expression (3) is the constant term obtained in the second learning. The model generation unit 5 then uses x_{ig} obtained in the second feature value selection and expression (6) to obtain the indicator function χ_{s′}([i,j]), and substitutes the indicator function χ_{s′}([i,j]) into expression (3) to generate the prediction model.

The learning unit 3, the feature value selection unit 4, and the model generation unit 5 are realized, for example, by a CPU (Central Processing Unit) of a computer operating according to a learning program. In this case, the CPU may read the learning program from a program storage medium such as a program storage device of the computer, and operate as the learning unit 3, the feature value selection unit 4, and the model generation unit 5 according to the learning program.

The prediction model generated by the model generation unit 5 contains an indicator function. Therefore, it can be said that the prediction model is smaller in size. Therefore, according to the learning device of the present disclosure, the prediction model can be reduced in size.

As mentioned above, L in the first feature value selection is equal to or greater than L in the second feature value selection. That is, the number of feature values included in the subset in the first feature value selection may be equal to or greater than the number of feature values included in the subset in the second feature value selection. When the number of feature values in the subset in the first feature value selection is greater than the number of feature values in the subset in the second feature value selection, the number of feature values in the subset in the first feature value selection is, for example, 14-28% more than the number of feature values in the subset in the second feature value selection. However, this value is an example and is not limited to this value. The number of epochs in the first learning may be less than the number of epochs in the second learning. For example, the number of epochs in the first learning may be ⅓ of the number of epochs in the second learning, or less than ⅓ of the number of epochs in the second learning.

In the above example embodiment, the case of learning in the FFM is used as an example, but the learning device of the present disclosure can also be applied to learning in the FM.

The following are examples. In each example, an expression without the second term on the right side of expression (1) was used instead of expression (1).

### Example. 1

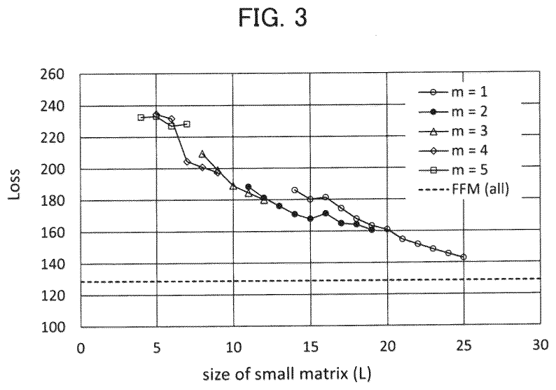

To see to what extent the sum of the cross terms generated from the subsets can reproduce the original learning model, the relationship between (L, m) and the loss function was examined. Here, the loss is defined as the residual sum of squares of the true values and predicted values for the training data. FIG. 3 is a schematic diagram showing the behavior of loss when Lis varied in each case of m=1 to m=5. The dashed horizontal line is the values from the model that considers all nonzero matrix elements (i.e., the original FFM learning model). The maximum value of L that can be taken for each m is Lₘₐₓ(m)=floor (N/m). floor( ) represents the floor function. As L increases, the loss decreases. When L is the same, the larger m is, the lower the loss is. However, L has an upper bound Lₘₐₓ(m), and as m is increased, Lₘₐₓ(m) decreases. As m is increased, the total number of matrix elements in the cross terms generated from the subsets is asymptotically expressed as N(N−1)/(2 m), and the total number decreases. For example, when (L, m)=(7, 5), only about 15% of the original matrix elements are considered, which does not constitute a sufficiently loss-reducing model. Basically, when Lₘₐₓ His the maximum value of L that can be taken within hardware and other restrictions, it is preferable to set m^{H}=floor(N/Lₘₐₓ^{H}). Therefore, in the following, the case (Lₘₐₓ^{H}, m^{H})=(14, 2) is focused.

In example 1, the prediction model was generated after the first learning and the first feature value selection.

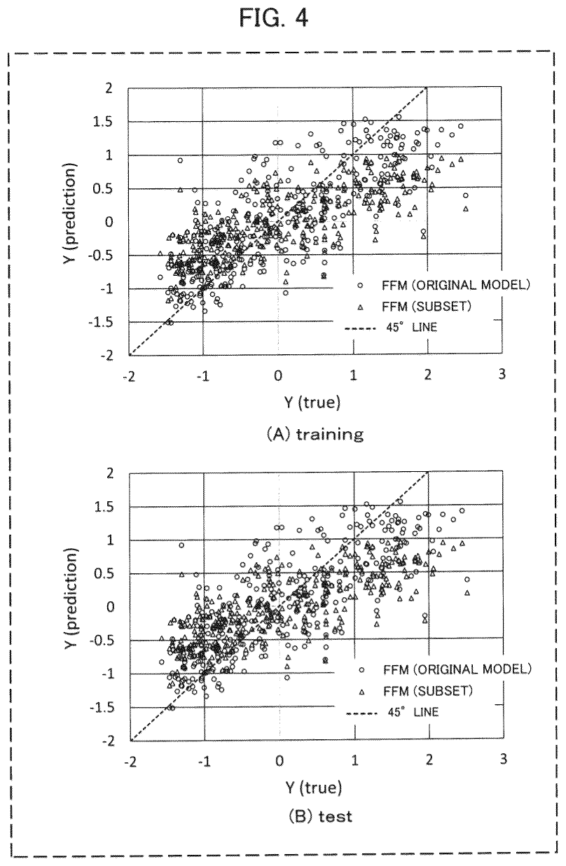

FIG. 4 is scatter plots of true values and predicted values. FIG. 4(A) is a scatter plot of true values and predicted values regarding the training data. FIG. 4(B) is a scatter plot of true values and predicted values regarding the test data. FIG. 4(A) and FIG. 4(B) show (yₖ, yₖ^{S′}\hat{ }) and (yₖ, yₖ^{A}\hat{ }). yₖ^{S′}\hat{ } is the predicted value for the k-th data due only to the constant term and the cross terms generated from the subsets, and is calculated in expression (3). On the other hand, yₖ^{A}\hat{ } is calculated by the original FFM model (in the examples, the expression without the second term on the right side of expression (1)) when considering all nonzero cross terms before selecting the subsets. 45° line corresponds to the case where the prediction is perfect. In comparison, in both the training data and the test data, the predicted value y\hat{ }tends to underestimate in regions where the value of the objective variable, y (the progression of the disease after one year), is large. In particular, this tendency is even stronger for yₖ^{S′}\hat{ }. The coefficient of determination of the model in expression (3) for the test data (0.398) is slightly lower than the coefficient of determination of the original FFM model (0.428). Therefore, simply generating a prediction model after the first learning and the first feature value selection is insufficient to reproduce the original model. The coupling matrix of spins (weight matrix of cross terms) can be regarded as a hyperparameter in the optimization with the Ising model, since it is a parameter determined in the learning.

### Example. 2

In example 2, a prediction model (denoted as prediction model A) was generated after the first learning and the first feature value selection, and also a prediction model (denoted as prediction model B) was generated after the second learning and the second feature value selection.

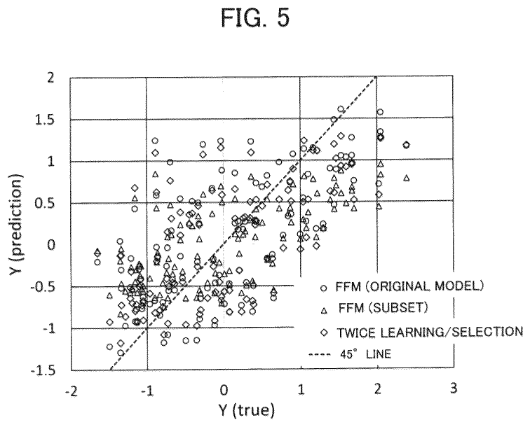

FIG. 5 is a scatter plot of true values and predicted values regarding the test data. The circle markers show the relationship between the true values and the predicted values when the original FFM model is used. The triangular markers show the relationship between the true values and the predicted values when prediction model A is used. The diamond-shaped markers show the relationship between the true values and the predicted values when prediction model B is used. FIG. 5 shows that the tendency to underestimate predicted values is improved in regions with large values of the objective variable y when using prediction model B generated after the second learning and the second feature value selection. In addition, the value of the coefficient of determination is improved from 0.398 to 0.420 when prediction model B is used.

In example 3 and example 4 below, the prediction models were generated after the first learning, the first feature value selection, the second learning, and second feature value selection.

### Example. 3

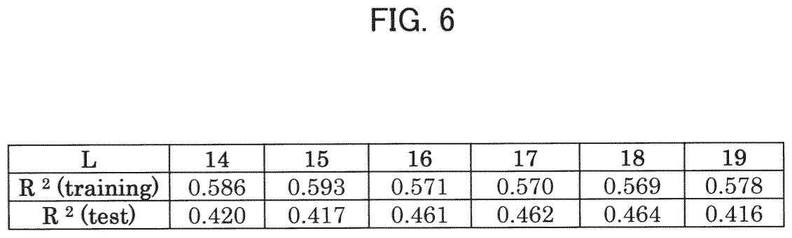

In example 3, (L,m)=(14,2) was used for the second feature value selection, as it is subject to hardware restrictions such as quantum computers. However, the first feature value selection need not be limited to (L, m)=(14,2). The number of the feature values in the examples is 38. Therefore, when two subsets are created and the number of subsets to which the individual feature values to be selected belong is at most one, the number of elements in each subset can be set to a maximum of 19. Therefore, the transition of the coefficient of determination of the prediction model generated after the second feature value selection was determined when the value of L was varied from 14 to 19 in the first feature value selection. In example 3, the transition of the coefficient of determination for the training data and the transition of the coefficient of determination for the test data were obtained. FIG. 6 is an explanatory diagram showing the transition of the coefficient of determination obtained in example 3. The coefficient of determination for the test data can be regarded as an indicator of generalization performance. When L is 18 in the first feature value selection, the coefficient of determination for the test data has a maximum value of 0.464. When L in the first feature value selection is between 16 and 18, the coefficient of determination for the test data is higher than the coefficient of determination of the original FFM model (0.428). Therefore, in this example, it is preferable to set L in the first feature value selection to one of 16-18 and L in the second feature value selection to 14. In this case, the number of feature values in the subset in the first feature value selection is 14-28% more than the number of feature values in the subset in the second feature value selection.

### Example. 4

Since the first feature value selection is a process to select effective feature values for the second learning, it does not necessarily need to be computed with high precision. Therefore, the number of epochs when obtaining the parameter w₀, and the latent vectors in the first learning does not have to be the number of epochs where the loss is sufficiently convergent. In other words, early stopping may be performed when obtaining the parameter w₀, and the latent vectors in the first learning. Then, the parameters wₗ₁ₗ₂ of the cross terms may be obtained by the inner product of the latent vectors. Then, the first feature value selection may be performed, followed by the second learning. In the second learning, the number of epochs when obtaining the parameter w₀, and the latent vectors, is such that the loss is sufficiently convergent (in this example, 300).

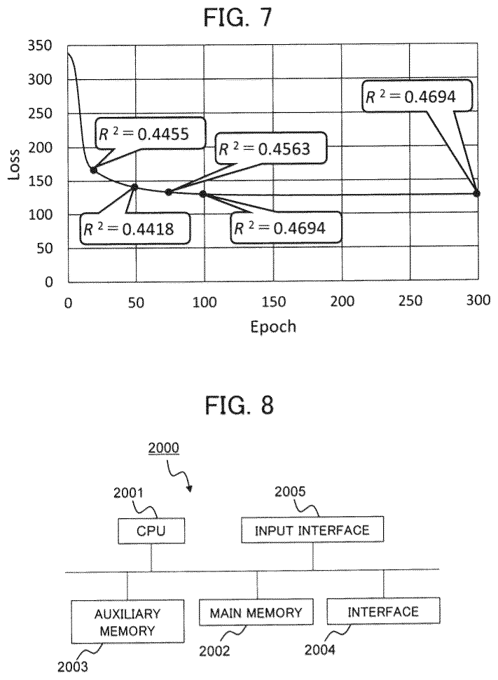

In example 4, the coefficients of determination for the test data were checked when the number of epochs in the first learning was less than the number of epochs in the second learning. In this case, in the first feature value selection, (L, m)=(18, 2) was used. In the second learning, the number of epochs when obtaining the parameter w₀, and the latent vectors was 300, and in the second feature value selection, (L, m)=(14, 2) was used. In the first learning, the number of epochs when obtaining the parameter w₀, and the latent vectors was set to 20, 50, 75, 100, and 300, and the coefficients of determination in each case were examined. FIG. 7 is an explanatory diagram showing the respective coefficients of determination when the number of epochs in the first learning is 20, 50, 75, 100, and 300. When the number of epochs in the first learning is set to 100, the same coefficient of determination is obtained as when the number of epochs is 300. Also, when the number of epochs in the first learning is set to 20, the loss is not fully converged, but the coefficient of determination of the final result is not much worse. Thus, the number of epochs in the first learning may be ⅓ of the number of epochs in the second learning, or it may be less than ⅓ of the number of epochs in the second learning.

FIG. 8 is a schematic block diagram showing an example configuration of a computer related to the learning device. The computer 2000, for example, includes a CPU 2001, a main memory 2002, an auxiliary memory 2003, an interface 2004, and an input interface 2005.

The learning device of the present disclosure is realized, for example, by a computer 2000. The operation of the learning device is stored in the auxiliary memory 2003 in the form of a program (learning program). The CPU 2001 reads the program from the auxiliary memory 2003, expands the program in the main memory 2002, and executes the process described in the above example embodiment according to the program.

The auxiliary memory 2003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via interface 2004.

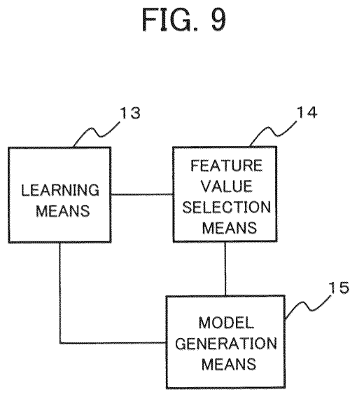

Next, an overview of the learning device pertaining to this disclosure is described. FIG. 9 is a block diagram showing an overview of the learning device of the present disclosure. The learning device includes learning means 13, feature value selection means 14, and model generation means 15.

The learning means 13 (e.g., the learning unit 3), when obtaining parameters of second-order cross terms of feature values and a constant term in a predetermined prediction model, performs first learning to obtain the constant term and latent vectors based on training data and to obtain the parameters by obtaining inner product of the latent vectors.

The feature value selection means 14 (e.g., the feature value selection unit 4), when the number of the feature values in a subset of the feature values is denoted as L and the number of the subsets is denoted as m, performs first feature value selection to create m subsets of the feature values including L feature values by optimizing objective function including the parameters and to select a predetermined number of feature values.

The learning means 13 obtains the constant term and the parameters by performing second learning similar to the first learning using the feature values included in each subset.

The feature value selection means 14 performs second feature value selection similar to the first feature value selection after the second learning.

The model generation means 15 (e.g., the model generation unit 5) generating a prediction model including an indicator function based on the constant term obtained by the second learning and the feature values selected by the second feature value selection.

Such a configuration can make the prediction model smaller.

In general, a large computer is not always available. Therefore, it is preferable that a prediction model (a learning model) used in a computer be small-scale.

According to the present disclosure, the prediction model can be made smaller.

The above example embodiment of the present invention may also be described as, but is not limited to, the following supplementary notes.

### (Supplementary Note 1)

A learning device comprising:
learning means for, when obtaining parameters of second-order cross terms of feature values and a constant term in a predetermined prediction model, performing first learning to obtain the constant term and latent vectors based on training data and to obtain the parameters by obtaining inner product of the latent vectors;
feature value selection means for, when the number of the feature values in a subset of the feature values is denoted as L and the number of the subsets is denoted as m, performing first feature value selection to create m subsets of the feature values including L feature values by optimizing objective function including the parameters and to select a predetermined number of feature values;
wherein
the learning means obtains the constant term and the parameters by performing second learning similar to the first learning using the feature values included in each subset, and
the feature value selection means performs second feature value selection similar to the first feature value selection after the second learning, and
wherein the learning device comprises:
model generation means for generating a prediction model including an indicator function based on the constant term obtained by the second learning and the feature values selected by the second feature value selection.

### (Supplementary Note 2)

The learning device according to supplementary note 1,
wherein the number of feature values included in the subset in the first feature value selection is greater than the number of feature values included in the subset in the second feature value selection.

### (Supplementary Note 3)

The learning device according to supplementary note 1 or supplementary note 2,
wherein the number of subset to which each feature value to be selected belongs is at most one in the first feature value selection and the second feature value selection.

### (Supplementary Note 4)

The learning device according to supplementary note 1 or supplementary note 2,
wherein the number of epochs in the first learning is less than the number of epochs in the second learning.

### (Supplementary Note 5)

A learning method, implemented by a computer, comprising:
when obtaining parameters of second-order cross terms of feature values and a constant term in a predetermined prediction model, performing first learning to obtain the constant term and latent vectors based on training data and to obtain the parameters by obtaining inner product of the latent vectors;
when the number of the feature values in a subset of the feature values is denoted as L and the number of the subsets is denoted as m, performing first feature value selection to create m subsets of the feature values including L feature values by optimizing objective function including the parameters and to select a predetermined number of feature values;
obtaining the constant term and the parameters by performing second learning similar to the first learning using the feature values included in each subset;
performing second feature value selection similar to the first feature value selection after the second learning; and
generating a prediction model including an indicator function based on the constant term obtained by the second learning and the feature values selected by the second feature value selection.

### (Supplementary Note 6)

The learning method according to supplementary note 5,
wherein the number of feature values included in the subset in the first feature value selection is greater than the number of feature values included in the subset in the second feature value selection.

### (Supplementary Note 7)

The learning method according to supplementary note 5 or supplementary note 6,
wherein the number of subset to which each feature value to be selected belongs is at most one in the first feature value selection and the second feature value selection.

### (Supplementary Note 8)

The learning method according to supplementary note 5 or supplementary note 6,
wherein the number of epochs in the first learning is less than the number of epochs in the second learning.

### (Supplementary Note 9)

A non-transitory computer-readable recording medium in which a learning program is stored, wherein the learning program causes a computer to execute:
a process of, when obtaining parameters of second-order cross terms of feature values and a constant term in a predetermined prediction model, performing first learning to obtain the constant term and latent vectors based on training data and to obtain the parameters by obtaining inner product of the latent vectors;
a process of, when the number of the feature values in a subset of the feature values is denoted as L and the number of the subsets is denoted as m, performing first feature value selection to create m subsets of the feature values including L feature values by optimizing objective function including the parameters and to select a predetermined number of feature values;
a process of obtaining the constant term and the parameters by performing second learning similar to the first learning using the feature values included in each subset;
a process of performing second feature value selection similar to the first feature value selection after the second learning; and
a process of generating a prediction model including an indicator function based on the constant term obtained by the second learning and the feature values selected by the second feature value selection.

Some or all of the configurations described in supplementary notes 2 to 4, which are dependent on supplementary note 1 described above, can be dependent on supplementary note 9 by the same dependency relationship as supplementary notes 2 to 4. Furthermore, not limited to supplementary note 1, supplementary note 5, and supplementary note 9, some or all of the configurations described as supplementary notes can be similarly subordinated to various hardware, software, various recording means for recording software, or systems, to the extent not deviating from the example embodiment described above.

While the present disclosure has been particularly shown and described with reference to example embodiment thereof, the present disclosure is not limited to this example embodiment. It will be understood by those of ordinary skill in the art that various changes in from and details may be made therein without departing from the spirit and scope of the present disclosure as defined by the claims. In addition, each embodiment can be appropriately combined with other embodiments.

The present invention can be suitably applied to a learning device that generates a prediction model.

What is claimed is:

1. A learning device comprising:
a memory configured to store instructions;
a processor configured to execute the instructions to:
when obtaining parameters of second-order cross terms of feature values and a constant term in a predetermined prediction model, perform first learning to obtain the constant term and latent vectors based on training data and to obtain the parameters by obtaining inner product of the latent vectors;
when the number of the feature values in a subset of the feature values is denoted as L and the number of the subsets is denoted as m, perform first feature value selection to create m subsets of the feature values including L feature values by optimizing objective function including the parameters and to select a predetermined number of feature values;
obtain the constant term and the parameters by performing second learning similar to the first learning using the feature values included in each subset,
perform second feature value selection similar to the first feature value selection after the second learning, and
generate a prediction model including an indicator function based on the constant term obtained by the second learning and the feature values selected by the second feature value selection.

2. The learning device according to claim 1,
wherein the number of feature values included in the subset in the first feature value selection is greater than the number of feature values included in the subset in the second feature value selection.

3. The learning device according to claim 1,
wherein the number of subset to which each feature value to be selected belongs is at most one in the first feature value selection and the second feature value selection.

4. The learning device according to claim 2,
wherein the number of subset to which each feature value to be selected belongs is at most one in the first feature value selection and the second feature value selection.

5. The learning device according to claim 1,
wherein the number of epochs in the first learning is less than the number of epochs in the second learning.

6. The learning device according to claim 2,
wherein the number of epochs in the first learning is less than the number of epochs in the second learning.

7. A learning method, implemented by a computer, comprising:
when obtaining parameters of second-order cross terms of feature values and a constant term in a predetermined prediction model, performing first learning to obtain the constant term and latent vectors based on training data and to obtain the parameters by obtaining inner product of the latent vectors;
when the number of the feature values in a subset of the feature values is denoted as L and the number of the subsets is denoted as m, performing first feature value selection to create m subsets of the feature values including L feature values by optimizing objective function including the parameters and to select a predetermined number of feature values;
obtaining the constant term and the parameters by performing second learning similar to the first learning using the feature values included in each subset;
performing second feature value selection similar to the first feature value selection after the second learning; and
generating a prediction model including an indicator function based on the constant term obtained by the second learning and the feature values selected by the second feature value selection.

8. A non-transitory computer-readable recording medium in which a learning program is stored, wherein the learning program causes a computer to execute:
a process of, when obtaining parameters of second-order cross terms of feature values and a constant term in a predetermined prediction model, performing first learning to obtain the constant term and latent vectors based on training data and to obtain the parameters by obtaining inner product of the latent vectors;
a process of, when the number of the feature values in a subset of the feature values is denoted as L and the number of the subsets is denoted as m, performing first feature value selection to create m subsets of the feature values including L feature values by optimizing objective function including the parameters and to select a predetermined number of feature values;
a process of obtaining the constant term and the parameters by performing second learning similar to the first learning using the feature values included in each subset;
a process of performing second feature value selection similar to the first feature value selection after the second learning; and
a process of generating a prediction model including an indicator function based on the constant term obtained by the second learning and the feature values selected by the second feature value selection.
